(19) United States
(12) Patent Application Publication
(10) Pub. No.: US 2002/0098467 A1
(43) Pub. Date: Jul. 25, 2002

(54) Muscle learning assemblage

(76) Inventor: Julie A. Dente, Ithaca, NY (US)

Correspondence Address: Salvatore C. Mitri, 263 Bryant Avenue, Staten Island, NY, 10306, US

(21) Appl. No.: 09/766,717

(22) Filed: Jan. 22, 2001

(51) Int. Cl. G09B 23/28

(52) U.S. Cl. 434/262; 434/274

(57) ABSTRACT

There is disclosed an assemblage for learning the muscle, muscle groups, muscle patterns and muscle sites of vertebrae animals including mammalians and humans. The assemblage includes a skeleton model of a vertebrae animal and a plurality of synthetically fabricated muscles having the same shape and size as the muscles of the skeleton model. Means are provided for removably attaching the fabricated muscles to the skeleton model so that students are able to learn the names, shapes, locations, actions and interactions of the muscles, muscle groups and muscle patterns of the skeleton model visually and tactilely.

### FIELD OF THE INVENTION

This invention is directed toward an assemblage for learning muscles. More particularly, this invention is directed toward an assemblage that permits students to learn the shape, name, location, actions and attachments of various muscles in vertebrae animals. Even more particularly, this invention is directed toward an assemblage that permits students to learn the shape, name, location actions and attachments of mammalian animals, including humans.

### BACKGROUND OF THE INVENTION

Presently, students of anatomy of vertebrae animals, including mammals and humans, learn the shape, name, location actions and attachments of the muscles of such animals by rote memorization. To assist the students, flash cards are typically used. The flash cards present an illustration of the various muscles, their names, the locations and the actions of the muscles on the particular vertebrate animal being studied. This is a tedious, time consuming effort that often leads to student frustrations and failures. Even when a student survives such an ordeal in order to pass a test, what has been strictly memorized can quickly be forgotten so that when a student eventually tries to put into practice what has been learned, the student must often resort to the flash cards used for learning in the first place.

### SUMMARY OF THE INVENTION

It has now been found that students of anatomy of vertebrae animals, including mammals and humans, can increase their retention and understanding of how different muscles of vertebrae animals function through a “hands on” approach to learning the shapes, names, locations and actions of these muscles using the assemblage of the invention. In general, the assemblage of the invention comprises: a skeleton model of a vertebrae animal; a plurality of fabricated muscles, said fabricated muscles having substantially the same shape and size as the muscles of said vertebrae animal and being capable of manual manipulation and contortion such that they simulate the same action of the muscles on said vertebrae animal; and, means to removably secure said fabricated muscles to said skeleton model.

In one embodiment, the vertebrae skeleton model is that of a mammalian animal, including a human.

In another embodiment, the fabricated muscles are provided from a synthetic or natural material such as latex, polyurethane foam, cotton, and the like, provided they are capable of being manually manipulated and contorted when placed in their proper positions on the skeleton model.

In a further embodiment, the means to removably secure the fabricated muscles to the skeleton model are provided by velcro strips or similar attachment means. Velcro strips or tabs are permanently secured by conventional means, such as by sewing, gluing, and the like, to that side of the fabricated muscles that are to be attached to the skeleton model. The sites on the skeleton model where the fabricated muscles are to be attached are provided with similar, but removable, velcro strips or tabs.

By utilizing the assemblage of the invention, students not only see the shapes of the muscles, but they can feel them, attach them at their appropriate locations on a skeleton model, group them, note the muscle patterns of groups of muscles, simulate the actions of the muscles, observe the interaction between muscles and groups of muscles, manipulate them, contort them, and the like. For example, pulling on a fabricated muscle pattern simulates a muscle contraction and thereby not only simulates the actions that the muscles produce, but also visually demonstrates how they act on the skeleton model being used. In short, students are now capable of having not only a visual but also a tactile experience with the muscles, muscle groups and muscle patterns that was not available to them before.

To further enhance the learning experience of students, a chart can be provided for a particular skeleton model illustrating the shapes of the different muscles, identifying muscle groups, listing muscles and muscle groups that correspond to different areas of the skeleton model and indicating the action and interaction of the muscles and muscle groups. Additionally, the chart can also provide instructions as to where the muscles and muscle groups are to be attached to a skeleton model. The chart can be readily used with the assemblage of the invention and serve as a supplemental teaching aid.

Another supplemental teaching aid that can be used with the assemblage of the invention as well as with the chart is a guide that labels and identifies each muscle pattern and muscle group.

In practice, a student would initially refer to the chart and/or guide to identify the muscles or muscle groups to be attached to a skeleton model. Next, the student would locate the proper sites on the skeleton model where the previously identified muscles or muscle groups are to be attached. Since each muscle has at least two points of attachment to a bone of a skeleton; i.e., an origin or proximal point and an insertion or distal point, a student would then locate the removable velcro strips or tabs at the origin and insertion points of the skeleton. The student would then select the proper fabricated muscle or muscle group to be removably secured to the appropriate origin and insertion points.

In this way, each student has the opportunity to learn the proper attachment sites of multiple muscles and muscle groups and attach muscle patterns on a skeleton model. After being removably attached to the skeleton model, the student can then manually manipulate and contort the fabricated muscles to simulate the same contractions and induce the same performances as the muscles on an actual vertebrae animal, including mammals and humans.

The muscle assemblage of the invention lends itself to the study of muscles in all vertebrae animals as it enables students to learn the names and locations of various muscles, muscle groups and muscle patterns of a particular vertebrae animal visually and tactilely thereby enhancing their retention capabilities. Consequently, the assemblage of the invention can be utilized by students in the study of medicine, veterinary medicine, animal husbandry, and the like. Since the assemblage of the invention permits students to touch, feel and manipulate the fabricated muscles and observe their interaction, it is a particularly useful learning aid to those students studying physical and occupational therapy.

### BRIEF DESCRIPTION OF THE DRAWING

The muscle learning assemblage of the invention is further illustrated in the accompanying drawing wherein:

FIG. 1 is an elevation view of a model of a human skeleton; and,

FIGS. 2a-2g are plan views illustrating various representative fabricated muscle shapes for the human skeleton.

### DETAILED DESCRIPTION OF THE INVENTION AND THE DRAWING

The muscle learning assemblage of the invention will become more apparent from the ensuing description when considered together with the accompanying drawing wherein like reference numerals denote like parts.

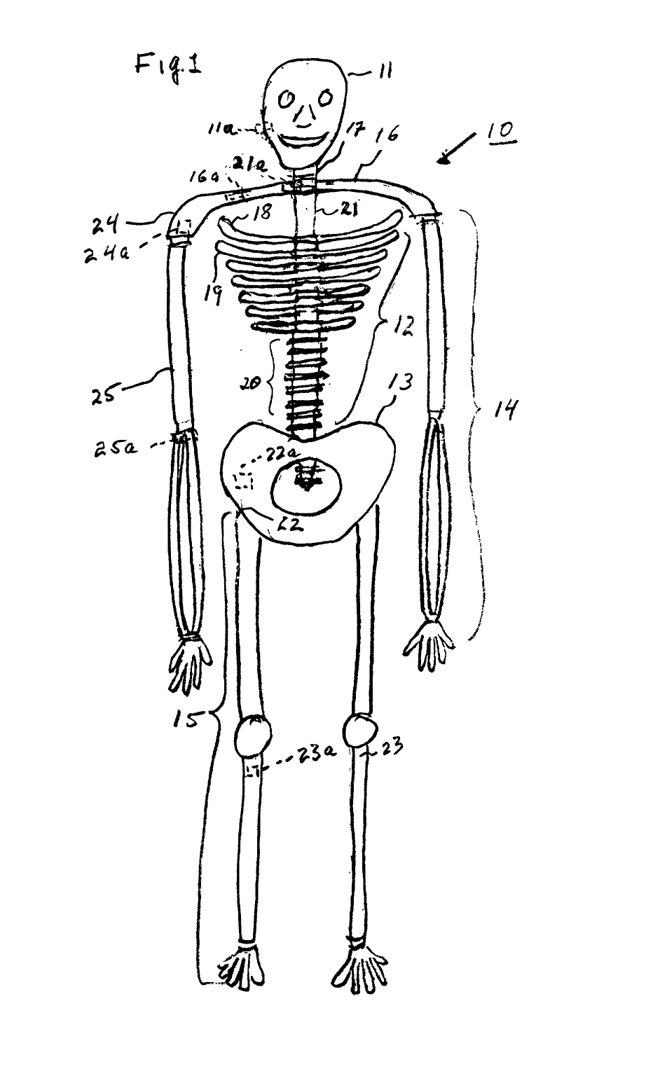

As can be seen in FIG. 1, typical components of a commercially available model of a human skeleton, generally identified by reference numeral 10, include a skull 11, a torso or upper body portion 12, a pelvic area 13, an upper extremity (arms and hands) 14, a lower extremity (legs and feet) 15, a clavicle or collar bone 16, a cervical spine or neck 17, a first rib 18, a second rib 19, a thoracic spine or back 20, a manubrium or breast bone 21, a hip 22, a knee 23, a scapula or shoulder blade 24 and the radius of the forearm 25.

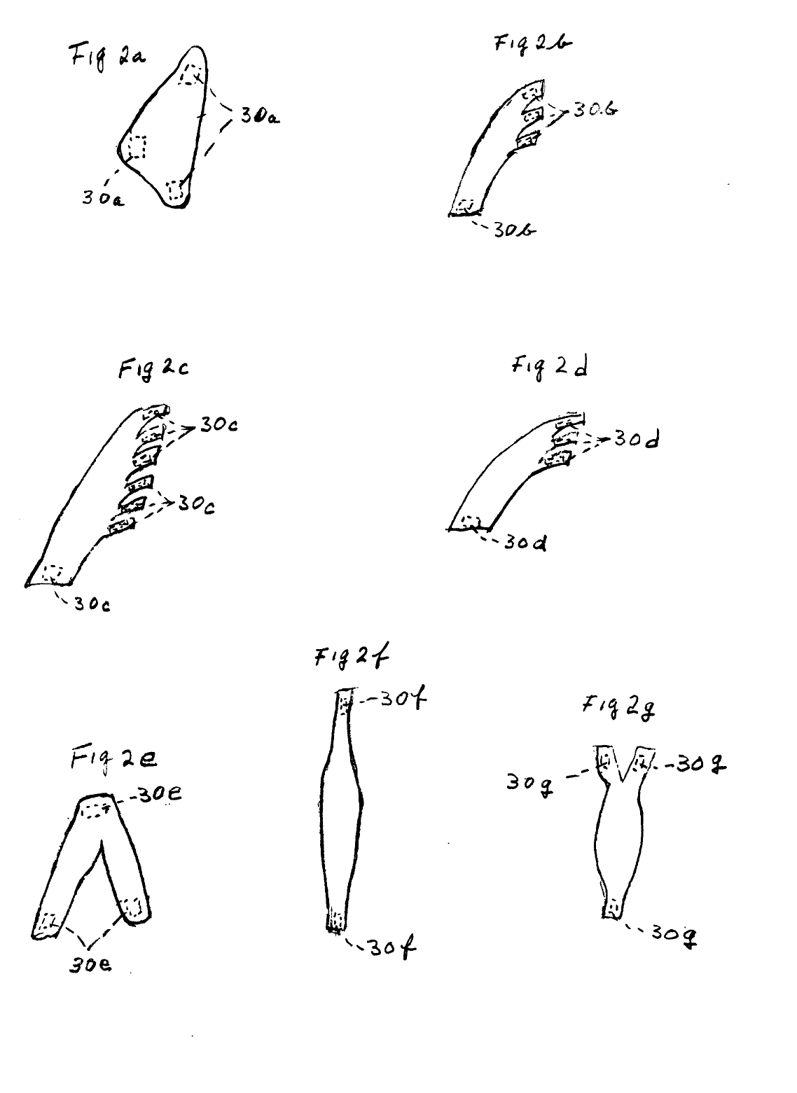

Representative fabricated muscle shapes that can be attached to the skeleton model shown in FIG. 1 are illustrated in FIGS. 2a-2g. FIG. 2a is a generally triangularly shaped fabricated muscle representative of the trapazius muscle that connects the skull 11 to the cervical spine or neck 17. FIG. 2b is a generally rectangular shaped fabricated muscle representative of the anterior scalene that connects the cervical spine or neck 17 to the first rib 18. FIG. 2c is a generally rectangular shaped fabricated muscle representative of the middle scalene that also connects the cervical spine or neck 17 to the first rib 18. FIG. 2d is a generally rectangular shaped fabricated muscle similar to that of FIG. 2b that is representative of the posterior scalene that connects the cervical spine or neck 17 to the second rib 19. FIG. 2e is a generally inverted V-shaped fabricated muscle representative of the sternocleidomastoid muscle that connects the skull 11 to the clavicle or collar bone 16 and the manubrium or breast bone 21. FIG. 2f is a generally elongated, oblong shaped fabricated muscle representative of the rectus femoris that connects the hip 22 to the knee 23. FIG. 2g is a generally elongated, oblong shaped fabricated muscle with a Y-shaped top representative of the biceps muscle pattern that connects the scapula or shoulder blade 24 to the radius of the forearm 25.

As can be seen in FIGS. 2a-2g, one or more velcro strips or tabs, shown in phantom at 30a-30g, are permanently secured by conventional means on the fabricated muscle shapes at the point or points where the fabricated muscle is to be removably attached to a bone of the skeleton model 10.

With reference again to FIG. 1, reference numerals 11a, 22a and 24a identify velcro tabs placed on origin (proximal) attachment points shown in phantom and reference numerals 16a, 21a, 23a and 25a identify velcro tabs placed on insertion (distal) attachment points, also shown in phantom, for the muscles illustrated in FIGS. 2e, 2f and 2g. Thus, a student can, for example, attach the sternocleidomastoid muscle illustrated in FIG. 2e at origin point 11 a and insertion points 16a and 21a to simulate lateral flexion and forward flexion actions of the cervical spine or neck 17. In a similar manner, a student can attach the rectus femoris muscle illustrated in FIG. 2f to origin point 22a and insertion point 23a to simulate leg extension and thigh flexing actions. In like manner, a student can attach the biceps muscle pattern illustrated in FIG. 2g to origin point 24a and insertion point 25a to simulate forearm and arm flexing and forearm supination actions.

Although the muscle learning assemblage of the invention has been described with particularity and in some detail, it will be appreciated by those skilled in the art that changes and modifications can be made therein without departing from the scope and spirit of the invention.

What is claimed:

1. A muscle learning assemblage comprising:
(a) a skeleton model of a vertebrae animal;
(b) a plurality of fabricated muscles representing the muscles of said skeleton model, said fabricated muscles being capable of manual manipulation and contortion simulating the same action as the muscles of said animal; and,
(c) means to removably attach said fabricated muscles to said skeleton model.

2. The assemblage of claim 1 wherein said skeleton model is that of a mammalian animal.

3. The assemblage of claim 3 wherein said skeleton model is that of a human.

4. The assemblage of claim 1 wherein said muscles are fabricated from a synthetic plastic or natural material.

5. The assemblage of claim 4 wherein said plastic material is latex.

6. The assemblage of claim 4 wherein said natural material is cotton.

7. The assemblage of claim 1 wherein said removable attachment means is velcro.

8. A muscle learning assemblage comprising:
(a) a skeleton model of a mammalian animal;
(b) a plurality of fabricated muscles obtained from a synthetic plastic or natural material said fabricated muscles representing the same shape and size as the muscles of said skeleton model and being capable of manual manipulation and contortion such as to simulate the same action as the muscles of said mammalian animal; and,
(c) means to removably attach said fabricated muscles to said skeleton model.

9. The assemblage of claim 8 wherein said skeleton model is that of a human.

10. The assemblage of claim 8 wherein said synthetic plastic material is latex.

11. The assemblage of claim 8 wherein said natural material is cotton.

12. The assemblage of claim 8 wherein said removable attachment means is velcro.

13. A muscle learning assemblage comprising:
(a) a skeleton model of a human;
(b) a plurality of fabricated latex muscles representing the same shape and size as the muscles of said skeleton model said fabricated muscles being capable of manual manipulation and contortion such as to simulate the same action as the muscles of said skeleton model; and,
(c) means to removably attach said fabricated muscles to said skeleton model.

14. The assemblage of claim 13 wherein said removable attachment means is velcro.
